(19) United States
(12) Patent Application Publication
(10) Pub. No.: US 2022/0128122 A1
(43) Pub. Date: Apr. 28, 2022

(54) CVT PLATE LINK CHAIN HAVING CLEAN CONTACT BETWEEN PRESSURE PIECE AND PLATE

(71) Applicant: Schaeffler Technologies AG & Co. KG, Herzogenaurach (DE)

(72) Inventor: Manuel Falk, Baden Baden (DE)

(73) Assignee: Schaeffler Technologies AG & Co. KG, Herzogenaurach (DE)

(21) Appl. No.: 17/427,776

(22) PCT Filed: Feb. 6, 2020
(86) PCT No.: PCT/DE2020/100073

§ 371 Date: Aug. 2, 2021

(30) Foreign Application Priority Data
Feb. 19, 2019 (DE) 102019104177.5

(51) Int. Cl. F16G 13/04; F16G 15/12

(52) U.S. Cl. CPC F16G 13/04; F16G 15/12

(57) ABSTRACT

A plate link chain for a motor vehicle drive having a continuously variable transmission includes a pressure piece with a first bearing face and a second bearing face, and a plate with a third bearing face and a fourth bearing face. The first bearing face and the third bearing face bear against one another to form a force transmitting outer contact region relative to a rotation direction of the plate link chain, and the outer contact region forms an outer contact face that is linear or flat and encloses an angle α that is ≥160° and ≤180°. The second bearing face and the fourth bearing face bear against one another to form a force transmitting inner contact region relative to the rotation direction, and the inner contact region forms an inner contact face enclosing an angle that is ≥90° and ≤135°.

### CROSS-REFERENCE TO RELATED APPLICATIONS

This application is the United States National Phase of PCT Appln. No. PCT/DE2020/100073 filed Feb. 6, 2020, which claims priority to German Application No. DE102019104177.5 filed Feb. 19, 2019, the entire disclosures of which are incorporated by reference herein.

### TECHNICAL FIELD

The disclosure relates to a plate link chain for a motor vehicle drive having a continuously variable transmission, said plate link chain having plates which are articulated to one another via pressure pieces. Bearing faces are formed on each of the pressure pieces and the plates, via which bearing faces the pressure pieces and the plates bear against each other, forming contact regions for force transmission. The pressure pieces and the plates each have at least two bearing faces forming contact regions, and a pressure piece and a plate bear against each other via the contact regions for force transmission such that on one side, on an outer contact region as seen in the rotation direction of the plate link chain, a first contact face is produced which is linear or flat and thus encloses an angle α, and on the other side, on an inner contact region, a second contact face is produced which encloses an angle β. The angles α and β could, each individually, also be referred to as “wrap angles”.

### BACKGROUND

In known CVT chains, when the load is low, contact between the plates and the pressure pieces takes place mainly in the area of the transverse brackets of the plate located orthogonally to the longitudinal center axis of the chain, so that a force vector is created that is oriented at a flat angle relative to the longitudinal axis of the plate link chain/plate. In addition, the force introduction point into the plate is relatively distanced from the longitudinal bracket transmitting tensile forces in the chain, so that a large lever arm arises with correspondingly large torques acting on the longitudinal bracket, which leads to a large bracket bending and plate load. In the event of a high load, i.e., large tensile forces acting in the chain, the contact point/force introduction point migrates outwards in the direction of the longitudinal brackets, i.e., away from the longitudinal center axis, as a result of this deformation of the plate. As a result, as the load increases, the force vector aligns itself at a steeper angle with respect to the longitudinal axis of the plate/plate link chain and its radial force component is increased. The exact direction of the force vector depends heavily on geometric deviations and/or tolerances of the plate and pressure piece, so that high variations in the chain strength can occur.

From WO2006/058529 A1, a plate link chain, in particular for a vehicle drive, is known, with a plurality of plates articulated to one another via pressure pieces. The pressure pieces run transversely to the longitudinal direction of the plate link chain and respective curved bearing faces are arranged on the pressure pieces and the plates, along which bearing faces the pressure pieces and plates bear against each other for force transmission. Curved rolling surfaces are arranged on the pressure pieces, along which the pressure pieces roll against one another for force transmission. The pressure pieces are designed to be asymmetrical in the pressure piece height direction in a cross section running in the longitudinal direction of the plate link chain. The bearing faces are provided on the upper and lower contact face area between the pressure piece and the plate in the pressure piece height direction.

The design according to this publication offers the advantage of high chain rigidity in the longitudinal direction, low contact slip when the load changes, and a defined installation position. However, when the load transmitted is relatively low, the contact is mainly in the area of the transverse bracket of the plate that is orthogonal to the longitudinal center axis, so that a flat force vector and a relatively large lever arm are created. The disadvantageous consequence is a major deformation of the plate. When a relatively high load is transmitted, the contact is shifted in the direction of the longitudinal bracket as a result of a greater deformation. This increases the radial force component. As a result, the force vector becomes steeper, which counteracts the bracket bending. This characteristic has the disadvantage that the force vector is initially relatively flat when the load is relatively low, with the result of a large degree of bracket bending, constriction of the plate and increased loads on the plate. The direction of the force vector reacts very sensitively to geometric deviations. This leads to high variations in chain strength.

A plate link chain, in particular a plate link chain for a continuously variable transmission of a motor vehicle, is known from WO2014/090241 A1. This has plates that are articulated to one another by pairs of rocker pressure pieces. The pairs of rocker pressure piece each include two rocker pressure pieces, with the plates and the rocker pressure pieces being designed and bearing against each other in such a way that the plate brackets of the plates are loaded almost free of torques when the plate link chain is in operation. With this design, defined force vectors can be created that are less sensitive to geometric deviations. The result is a smaller variation of the chain strength and a steeper position of the force vectors between the pressure pieces and the plates, which leads to a reduction in bracket bending and/or plate constriction. However, a lower chain stiffness in the longitudinal direction, increased slip in the event of load changes such as chain rotation in the contact region between the plate and pressure piece, the risk of wear-based failure and the risk of incorrect positioning of the pressure piece are disadvantageous.

It has been found that during operation of conventional plate link chains, high stress gradients and thus stress peaks occur on all four brackets of the plates, which are caused by high bending torques in the plate brackets, which limits the tensile strength of the plate link chains and thus the torque range. In the event of failure, the plates break at points with high stress peaks.

### SUMMARY

The present disclosure provides a plate link chain that does not have the disadvantages mentioned and facilitates, in particular, an optimization of the contact between plate(s) and pressure piece(s) and, associated therewith, an improvement in the chain strength as well as an improvement of known plate link chains, in particular with regard to their service life and/or their strength.

In a plate link chain of the generic type, this object is achieved according to the disclosure in that the angle α≥160° and ≤180° and the angle β is ≥90° and ≤135°. Basically, it should be mentioned that the outer contact regions/contact faces can also be arranged on the inside and vice versa.

With conventional plate link chains, the contacts between the rocker pressure pieces and the plates are not clearly defined and sometimes change significantly when the load changes. The problem here is that an unfavorable introduction of force into the plate promotes deformations of the plate, which deformations in turn can cause a change in the force introduction both in terms of location and direction, which in turn can result in changes in the shape of the plate. Therefore, there are undesirable fluctuations in the effect of the force, in particular also changes in the effective direction of force, as well as a strong tolerance dependency. Due to the contact faces formed according to the disclosure, the contacts between the pressure piece and the plate are more clearly defined. Due to the larger number of bearing faces and contact regions, changes in the shape of the plate and changes in the direction and height of the acting force are reduced. With the plate link chain according to the disclosure, higher tensile forces can be transmitted than with conventional plate link chains.

For example, the disclosure provides the following benefits relative to known plate link chains: With a given torque capacity, the chain size of the plate link chain can be reduced, which in turn leads to an improvement in acoustic properties. In addition, a greater spread can be achieved. Alternatively or additionally, the chain width of the plate link chain can be reduced, which can lead to reduced manufacturing costs. Finally, the mass of the plate link chain can be reduced.

The second contact face may have an angle δ facing the first contact face, for example as a partial angle or partial area, which is ≥5° and ≤30° and/or the second contact face may have an angle γ facing away from the first contact face, for example as a partial angle or partial area, which is ≥0° and ≤15°.

For example, the angle α may be ≥110° and ≤120°.

The shape of the second contact face may be determined at least in sections or completely by a circular-cylindrical cylinder or a sphere.

In a further development, for example, the pressure pieces and the plates can each have at least three bearing faces and a pressure piece and a plate bear against each other via the at least three contact regions for force transmission (in particular/preferably at each operating time). Two pressure pieces may each connect two plates with one another.

The pressure pieces and the plates may each have exactly three bearing faces forming contact regions and a pressure piece and a plate bear against each other via the precisely three contact regions for force transmission. This results in a clear positioning between the pressure piece and the plate.

According to one embodiment, one of the three bearing faces is arranged on one side of the longitudinal center axis of the plate link chain both for the pressure pieces and the plates. Two of the three bearing faces are arranged on the other side of the longitudinal center axis of the plate link chain. In this way, a stable support relative to the longitudinal center axis is achieved.

In one embodiment, the plates each have two opposite transverse brackets and two opposite longitudinal brackets. The transverse bracket may be arranged essentially orthogonally to the longitudinal brackets and the longitudinal center axis of the plate link chain.

According to a further embodiment, in the case of the pressure pieces and plates, the bearing face arranged individually on one side of the longitudinal center axis may be aligned at an angle between 35° and 55°, between 40° and 50°, 45° or 43°±1° to the longitudinal center axis. Also, in the case of the pressure pieces and plates, one of the two bearing faces on the other side of the longitudinal center axis may be aligned parallel to the longitudinal center axis and the other of the two bearing faces arranged on the other side of the longitudinal center axis may be aligned transversely to the longitudinal center axis. In this way, the pressure piece and plate bear against each other in a defined manner at their (for example three) bearing points.

In the case of the plates, one of the two bearing faces arranged on the other side of the longitudinal center axis can be formed on one of the longitudinal brackets. In this way, secure contact with the bearing face located on the other side of the longitudinal center axis is ensured. In addition, this favors an angle of the force vector that is as flat as possible relative to the longitudinal center axis. The other of the two bearing faces arranged on the other side of the longitudinal center axis can be formed on one of the transverse brackets. This effects a good and direct load transfer in the longitudinal direction of the chain.

The bearing faces may be designed to be flat. This favors a precisely defined position and alignment of the force vectors acting between the pressure piece and the plate, as well as simple production. Alternatively, one, two or all three bearing faces can be curved, which promotes a soft and harmonious displaceability of the plate and pressure piece relative to one another. For example, the bearing face or the bearing faces can be designed as roller bearing surfaces which cause the pressure piece and plate to roll against one another.

In another embodiment, the two bearing faces arranged on one side of the longitudinal center axis adjoin one another or merge into one another. This results in the formation of a large contact face with good power transmission.

The pressure pieces can be designed as rocker pressure pieces and arranged as pairs of rocker pressure pieces and assigned to one another. Curved rolling surfaces can be arranged on the pressure pieces, along which the pressure pieces roll against each other for force transmission. They bear against each another in a rolling region by means of their rolling surfaces. The center of this rolling region can represent a design-relevant rolling point, which, however, can be located elsewhere depending on the loads occurring during operation.

It can also be said that, according to the disclosure, an oblique contact is provided in the side or transverse bracket and in the longitudinal or lower bracket on one side of the longitudinal center axis or above, and contacts are provided in the side or transverse bracket and in the longitudinal or lower bracket on the other side of the longitudinal center axis or below. The last two contacts mentioned can be connected to one another in order to enlarge the contact face. The described geometry can also be mirrored horizontally within the scope of the disclosure, i.e. the oblique contact is formed below and the contact above in the side bracket and upper bracket.

### BRIEF DESCRIPTION OF THE DRAWINGS

In the following, the disclosure is explained in more detail with reference to drawings. In the drawings:

FIG. 1 shows a schematic representation of part of a plate of a plate link chain known from the prior art by the applicant (for example CL05 or CL06 or CL07),

FIG. 2 shows a schematic representation of part of a plate of a further plate link chain known from the prior art by the applicant (for example CL05 or CL06 or CL07),

FIG. 3 shows a schematic representation of part of a plate of a plate link chain according to a first embodiment of the disclosure and

FIG. 4 shows a schematic representation of a second embodiment of the disclosure.

The figures are only schematic in nature and serve only for comprehension of the disclosure. The same or equivalent elements are provided with the same reference symbols.

### DETAILED DESCRIPTION

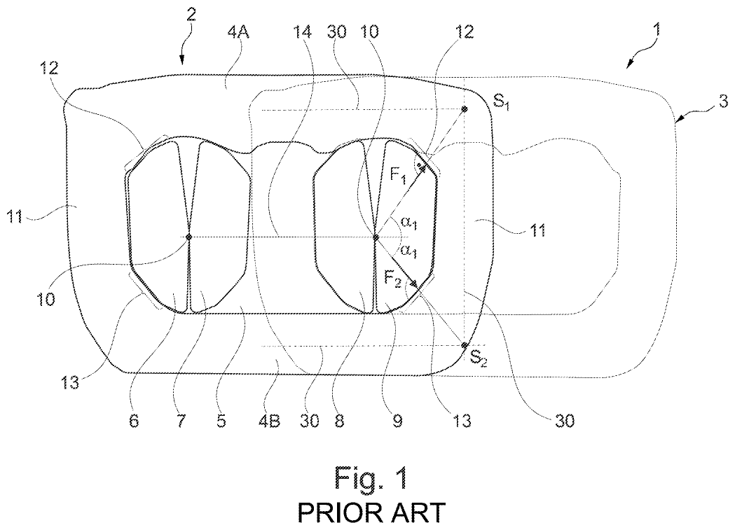

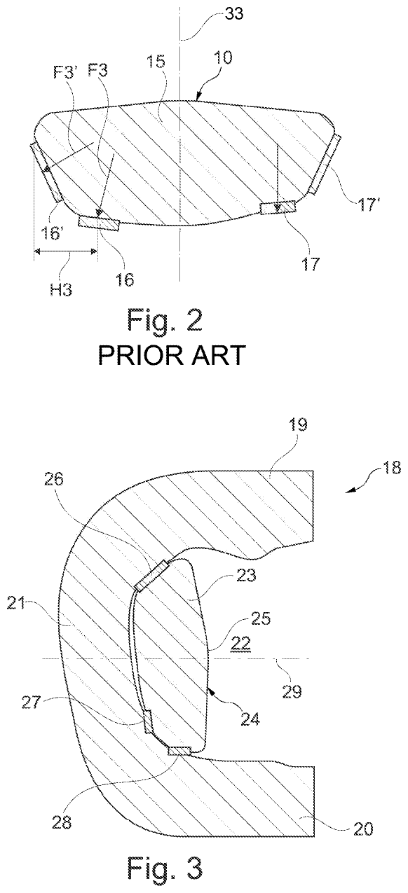

FIGS. 1 and 2 show schematic representations of subsections from the plate link chains known from the prior art.

FIG. 1 shows a plate link chain 1 with two plates 2 and 3. The plate 2 includes an upper bracket 4A and a lower bracket 4B. The plate 2 includes an opening 5 into which a total of four rocker pressure pieces 6, 7, 8, 9 engage. The rocker pressure pieces 8 and 9 represent a first pair of rocker pressure pieces. The rocker pressure pieces 6 and 7 represent a second pair of rocker pressure pieces. The first pair of rocker pressure pieces with the rocker pressure pieces 8 and 9 represents a first rocker joint which couples the two plates 2 and 3 to one another. The rocker pressure pieces 6, 7 and 8, 9 of a pair of rocker pressure pieces bear against one another in rolling regions. In the embodiment shown, a rolling point 10 is arranged in the middle of the rolling regions.

A first flat contact face 12 is formed between the rocker pressure piece 9 and a bracket connection area which connects the upper bracket 4A to a side bracket 11, which is also referred to as a transverse bracket 11. A second flat contact face 13 is formed between the rocker pressure piece 6 and a bracket connection area which connects the lower bracket 4B to the side bracket 11. The flat contact faces 12 and 13 represent defined bearing faces between the rocker pressure piece 6 and the plate 2. The rocker pressure piece 6 is in contact with the plate 2 in a corresponding manner via the opposing contact faces 12, 13.

The forces F1 and F2 transmitted via the contact faces 12, 13 between the pressure piece 9 and the plate 2 are shown in FIG. 1. The lines of action of the forces F1 and F2 each run through the rolling point 10 and an intersection point S1 or S2 of neutral fibers 30, indicated by dashed lines, of the brackets 4A, 4B and 11 of the plate 2. The angles of inclination of the lines of action of the forces F1 and F2 relative to the longitudinal center axis 14 of the plate link chain are denoted by α1 and α2 in FIG. 1.

A pressure piece 15 of another plate link chain known from the prior art is shown in FIG. 2. Together with a plate, not shown in the figure, which is designed essentially similar to the plate 2 in FIG. 1, the pressure piece 15 forms two contact faces 16, 17 which are designed essentially transversely to the longitudinal center axis 33 on the transverse bracket. With the exception of the design of the bearing faces 16, 17, the plate corresponds to the plate 2 shown in FIG. 1.

The design of the contact faces 16, 17 according to FIG. 2 offers the advantages of high chain rigidity in the longitudinal direction, low contact slip when the load changes, and a defined installation position. In the case of a relatively low load transmitted via the plate link chain, the contact is mainly in the vertical area of the transverse brackets. This creates a flat force vector F3 and a relatively large lever arm H3, which leads to a large deformation of the plate. When a relatively high load is transferred, the contact is shifted more in the direction of the longitudinal bracket to the contact points 16′ and 17′ as a result of a larger deformation. This increases the radial force component. As a result, the force vector F3′ becomes steeper, which counteracts the bracket bending. This characteristic has the disadvantage that the force vector is initially relatively flat when the load is relatively low, with the result of a large degree of bracket bending, constriction of the plate and increased loads on the plate. The direction of the force vector reacts very sensitively to geometric deviations. This leads to high variations in chain strength.

The embodiment according to FIG. 1 serves in the context of a further development of the embodiment according to FIG. 2 to achieve more defined force vectors that react less sensitively to geometric deviations. The result is a smaller variation in the chain strength and a steeper position of the force vectors F1, F2 to reduce bracket bending and/or plate constriction. The disadvantage of this embodiment is a lower chain stiffness in the longitudinal direction, increased slip in the event of load changes such as chain rotation in the contact region between the plate and the pressure piece/rocker pressure piece, the risk of wear-based failure and the risk of incorrect positioning of the pressure piece (a slightly twisted pressure piece might not come to the correct installation position due to the acting load).

FIG. 3 shows part of a plate 18 of a plate link chain according to an example embodiment. The plate 18 includes an upper bracket 19 and a lower bracket 20, both of which are also referred to as longitudinal bracket 19, 20, and a side bracket 21, which is also referred to as transverse bracket 21. The two longitudinal brackets 19, 20 are connected to each other on the one hand with the transverse bracket 21 and on the opposite side with a further transverse bracket (not shown in the figure), so that the two longitudinal brackets 19, 20 with the two transverse brackets 21 form the plate 18 which is closed in the circumferential direction. The plate 18 thus includes an opening 22 surrounded by the longitudinal brackets 19, 20 and the transverse brackets 21. The transverse bracket 21 is arranged essentially orthogonally to the longitudinal brackets 19, 20 and the longitudinal center axis 29 of the plate 18.

In the opening 22, a total of four pressure pieces are arranged, of which only one pressure piece 23 is shown to allow better clarity of the figure. The pressure pieces 23 are also referred to as rocker pressure pieces 23 and are arranged in such a way that two pressure pieces 23 each form a pair of rocker pressure pieces. Each pair of rocker pressure pieces forms a rocker joint, with which the plate 18 and a further plate adjoining this (not shown in the figure) are or will be articulated to one another. The rocker pressure pieces 23 of a pair of rocker pressure pieces bear against each another in rolling regions 24 and roll against one another thereon. In FIG. 3, the rolling region 24 and a rolling point 25 located centrally therein are shown.

According to the embodiment, a total of, for example, exactly three bearing or contact faces 26, 27, 28 are formed and arranged between the pressure piece 23 and the plate 18. In each case, a bearing face 26 is arranged on one side of the longitudinal center axis 29 of the plate link chain or plate 18. The two remaining bearing faces 27, 28 are arranged on the other side of the longitudinal center axis 29. In this way, it is ensured that a pressure piece 23 and a plate 18 always bear against each other via exactly three contacts for force transmission, so that a clearly defined contact is effected. With the exception of the design of the bearing faces 26, 27, 28, the plate 18 corresponds to the plate 2 shown in FIG. 1.

In the embodiment shown in FIG. 3, the bearing face 26 is oriented obliquely at an angle of approximately 45′ to the longitudinal center axis. The bearing face 28, on the other hand, is aligned on the longitudinal bracket 20 parallel to the longitudinal center axis 29. Finally, the bearing face 27 is aligned on the transverse bracket 21 transversely to the longitudinal center axis 29. All bearing faces 26, 27, 28 are designed to be flat. As a result of this design of the bearing faces 26, 27, 28, the force vector transmitted via the bearing face 26 can be aligned in a more defined manner, e.g., more steeply, than in the prior art. The plate link chain therefore reacts less sensitively to geometrical deviations, which results in a lower variation of the chain strength. In addition, a high chain rigidity in the longitudinal direction, a low contact slip in the event of load changes, a defined installation position of the pressure piece and a large contact region can be achieved.

For the sake of completeness, it should be pointed out that the arrangement shown in FIG. 3 can also be mirrored horizontally within the scope of the invention, i.e. that the oblique contact 26 below and the bearing faces 27, 28 above can be formed in the side bracket 19 and transverse bracket 21.

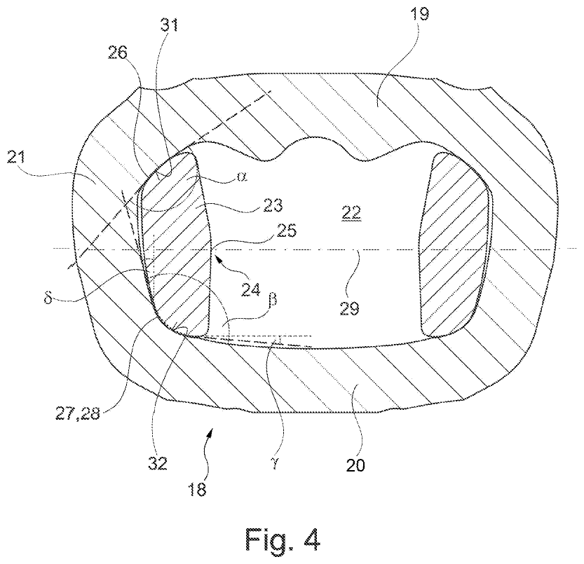

An example embodiment is shown schematically in FIG. 4. In this embodiment, the contact region 26 defines a first contact face 31. Furthermore, the contact regions 27 and 28 merge into one another (seamlessly/without transition) and define a second contact face 32.

There is an angle α in the area of the first contact face. It should be mentioned that there is usually a line contact there in the (almost) unloaded state, recognizable as a point in the section of FIG. 4, whereas, in the loaded state, this linear contact region widens to form a contact face, namely the first contact face 31, which is bent and thereby defines the angle α.

An angle β is enclosed in the area of the second contact face 32. The angle β is the sum of a 90° angle and the two angles δ and γ.

### REFERENCE NUMERALS

1 Plate link chain
2 Plates
3 Plates
4A, B Bracket, longitudinal bracket
5 Opening
6 Pressure piece, rocker pressure piece
7 Pressure piece, rocker pressure piece
8 Pressure piece, rocker pressure piece
9 Pressure piece, rocker pressure piece
10 Rolling point
11 Bracket, transverse bracket
12 Contact face
13 Contact face
14 Longitudinal center axis
15 Pressure piece
16 Contact face
17 Contact face
18 Plate
19 Bracket, longitudinal bracket
20 Bracket, longitudinal bracket
21 Bracket, transverse bracket
22 Opening
23 Pressure piece, rocker pressure piece
24 Rolling region
25 Rolling point
26 Contact face
27 Contact face
28 Contact face
29 Longitudinal center axis
30 Neutral fiber
31 First contact face
32 Second contact face
33 Longitudinal center axis

1.-10. (canceled)

11. A plate link chain for a motor vehicle drive having a continuously variable transmission, comprising:
a pressure piece comprising a first bearing face and a second bearing face;
a plate comprising a third bearing face and a fourth bearing face, the plate being articulated to another plate by the pressure piece, wherein:
the first bearing face and the third bearing face bear against one another to form a force transmitting outer contact region relative to a rotation direction of the plate link chain;
the outer contact region forms an outer contact face that is linear or flat and encloses an angle α that is ≥160° and ≤180°;
the second bearing face and the fourth bearing face bear against one another to form a force transmitting inner contact region relative to the rotation direction; and
the inner contact region forms an inner contact face enclosing an angle β that is ≥90° and ≤135°.

12. The plate link chain of claim 11 wherein a shape of the inner contact face comprises a circular-cylindrical cylinder or a sphere.

13. The plate link chain of claim 11 wherein:
the inner contact face has an angle δ facing the outer contact face which is ≥5° and ≤30°; or
the inner contact face has an angle γ facing away from the outer contact face which is ≥0° and ≤15°.

14. The plate link chain of claim 11 wherein:
the pressure piece comprises a fifth bearing face;
the plate comprises a sixth bearing face;
the fifth bearing face and the sixth bearing face bear against one another for form a force transmitting third contact region forming a third contact face;
one of the outer contact face, the inner contact face, or the third contact face is arranged on one side of a longitudinal center axis of the plate link chain; and
the other two of the outer contact face, the inner contact face, or the third contact face are arranged on the other side of the longitudinal center axis.

15. The plate link chain of claim 14 wherein the one of the outer contact face, the inner contact face, or the third contact face is aligned at an angle between 35° and 55° to the longitudinal center axis.

16. The plate link chain of claim 14 wherein:
one of the other two of the outer contact face, the inner contact face, or the third contact face is aligned parallel to the longitudinal center axis; and
the other one of the other two of the outer contact face, the inner contact face, or the third contact face is aligned transversely to the longitudinal center axis.

17. The plate link chain of claim 14 wherein:
the plate comprises a longitudinal bracket and a transverse bracket;
one of the other two of the outer contact face, the inner contact face, or the third contact face is formed on the longitudinal bracket; and
the other one of the other two of the outer contact face, the inner contact face, or the third contact face is formed on the transverse bracket.

18. The plate link chain of claim 14 wherein the inner contact face or the third contact face is flat.

19. The plate link chain of claim 14 wherein the other two of the outer contact face, the inner contact face, or the third contact face adjoin one another or merge into one another.

20. The plate link chain of claim 11 wherein the angle β is ≥110° and ≤120°.
